(19) United States
(12) Patent Application Publication
(10) Pub. No.: US 2021/0224710 A1
(43) Pub. Date: Jul. 22, 2021

(54) COMPUTER RESOURCE ALLOCATION AND SCHEDULING SYSTEM

(71) Applicant: Element AI Inc., Montreal (CA)

(72) Inventors: Jeremy BARNES, Australia (CA); Philippe MATHIEU, Montreal (CA); Jean RABY, Montreal (CA); Simon BELANGER, Montreal (CA); Francois-Michel L'HEUREUX, Montreal (CA)

(73) Assignee: Element AI Inc., Montreal, QC (CA)

(21) Appl. No.: 17/056,487

(22) PCT Filed: May 17, 2019
(86) PCT No.: PCT/CA2019/050674

§ 371 Date: Nov. 18, 2020

Related U.S. Application Data
(60) Provisional application No. 62/673,562, filed on May 18, 2018.

(51) Int. Cl. G06Q 10/06; G06Q 30/04; G06F 9/54

(52) U.S. Cl. CPC G06Q 10/06313; G06F 9/54; G06Q 30/04

(57) ABSTRACT

Systems and methods for use in scheduling processes for execution on one or more data processors. A centralized governor module manages scheduling processes requesting access to one or more data processors. Each process is associated with a project and each project is allocated a computing budget. Once a process has been scheduled, a cost for that scheduling is subtracted from the associated projects computing budget. Each process is also associated with a specific process agent that, when requested by the governor module, provides the necessary data and parameters for the process. The governor module can thus implement multiple scheduling algorithms based on changing conditions and on optimizing changing loss functions. A log module logs all data relating to the scheduling as well as the costs, execution time, and utilization of the various data processors. The data in the logs can thus be used for analyzing the effectiveness of various scheduling algorithms.

### TECHNICAL FIELD

The present invention relates to software. More specifically, the present invention relates to systems and methods for scheduling processes for execution on multiple data processors.

### BACKGROUND

The continuous development of both hardware and software technology has led to incredible leaps in both processing power and system capabilities. Current GPUs (graphics processing units) that are supposed to be dedicated to only graphics processing exceed the processing capabilities of full-fledged CPUs of yesteryear. At least because of such raw processing power, GPUs have been the data processor of choice when it comes to matrix and calculation heavy fields such as artificial intelligence and crypto-currency mining.

Currently, arrays of GPUs and other data processors can be used to develop computation intensive applications for both industry and academia. However, because software development may require access to such arrays of processing power, the question is fast becoming no longer one of “Can we do it?” but more of “Can we get computing time to do it?” Multiple software developers and software development projects in both companies and academic institutions are increasingly becoming faced with issues of resource management: the computing power and the requisite storage are available but which project/which developer receives access to such resources? Would it be the project headed by the most senior academic? Would it be the project with the most potential for profit? Or would it be the project that would use the resources the least? Also, which scheduling strategy would produce the most efficient (in terms of resource allocation) result?

To this end, there is therefore a need for systems and methods that can be used to probe and address the above issues. Preferably, such systems and methods would be flexible such that different strategies can be employed and tested. Also preferably, such systems and methods would allow for data gathering as these strategies are explored so that suitable analyses of the data can be performed.

### SUMMARY

The present invention relates to systems and methods for use in scheduling processes for execution on one or more data processors. A centralized governor module manages scheduling processes requesting access to one or more data processors. Each process is associated with a project and each project is allocated a computing budget. Once a process has been scheduled, a cost for that scheduling is subtracted from the associated project's computing budget. Each process is also associated with a specific process agent that, when requested by the governor module, provides the necessary data and parameters for the process. The governor module can thus implement multiple scheduling algorithms based on changing conditions and on optimizing changing loss functions. A log module logs all data relating to the scheduling as well as the costs, execution time, and utilization of the various data processors. The data in the logs can thus be used for analyzing the effectiveness of various scheduling algorithms.

In one aspect, the present invention provides a system for scheduling multiple processes for access to multiple data processors, the system comprising:
a governor module for determining which modules are to be assigned to which data processors based on an optimization of at least one loss function;
a billing module for subtracting a cost of a process accessing at least one of said multiple data processors from a project's computing budget when a process is scheduled for execution on at least one of said multiple data processors, each process being associated with a specific project and each project being assigned a predetermined computing budget;
a log module for logging schedules and costs for each process scheduled for execution on one of said multiple data processors;
a project database for storing data relating to each project, said data including each project's remaining computing budget and parameters for each project;
a plurality of process agents, each process agent being specific to one of said multiple processes, each process agent being for providing parameters and data regarding a specific process to said governor module;
a request database for storing requests from said multiple processes for access to one or more data processors of said multiple data processors, said requests in said request database including an identification of a process making said request;

wherein

when said governor module receives a request from said request database, said governor retrieves data and parameters for a process making said request from a request agent specific to said process making said request.

### BRIEF DESCRIPTION OF THE DRAWINGS

The embodiments of the present invention will now be described by reference to the following FIGURES, in which identical reference numerals in different FIGURES indicate identical elements and in which:

FIG. 1 is a block diagram of a system according to one aspect of the invention.

### DETAILED DESCRIPTION

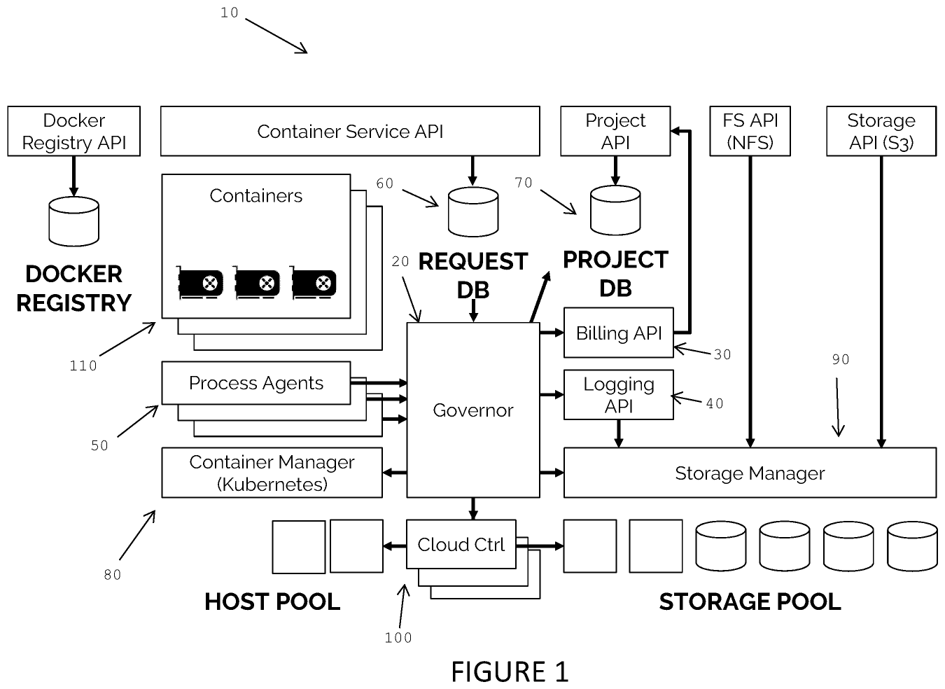

Referring to FIG. 1, a block diagram of a system according to one aspect of the invention is illustrated. As can be seen, the system 10 includes a governor module 20 that communicates with a billing module 30 and a logging module 40. The governor module 20 requests data from multiple process agents 50 and from a request database 60. In response to these requests, the governor module 20 receives data from these process agents 50 and from the request database 60. When necessary, the governor module 20 sends data to a project database 70, a container manager 80, a storage manager 90, and to one or more cloud controllers 100. In one implementation, the request database 60 only sends data to the governor module 20 in response to the governor module 20 requesting such data.

It should be clear that the scheduling of the requests for access to data processors is managed by the governor module 20. As an example, an incoming request is stored in the request database 60. When the governor module 20 receives the request from the database 60, the governor module 20 retrieves or receives information about the request from a relevant process agent 50. In one implementation, the governor module 20 is sent information from the relevant process agent 50 in response to a request for such information from the governor module 20. Once the relevant information has been received by the governor module 20, the governor module 20 then verifies if the budget for the project associated with the requesting process is sufficient for the projected cost of scheduling. Once the requesting process passes this check, the governor module then schedules one or more data processors to be used by the requesting process. Each requesting process is associated with a specific container 110 with the container containing (or having access to) the data, code, environment, and everything else needed by the process to execute. The governor module 20 thus communicates which process is to be assigned which data processor(s) and this is managed by the container manager 80. The container manager 120 thus ensures that the relevant data processor (or data processors since a process may request and be granted access to multiple data processors) is visible to and available to the container associated with the requesting process.

It should be clear that each process's process agent provides relevant information regarding the process to the governor module. This information may include an identification of the project associated with the process, the data used/required by the process, how many data processors may be required by the process, how many processes may run in parallel with the requesting process, what is the value created by the process once the process has completed, and what is the value lost (or opportunities bypassed) if the process is not executed in a timely manner. As noted above, the process agent may only provide this relevant information to the governor module only after the governor module requests such information.

Once a request has been granted by the governor module 20, a cost associated with the granting of that request is passed on to the billing module 30 by the governor module 20 along with an identification of the requesting process and along with any other relevant identification data. The billing module 30 then identifies the relevant project that the requesting process is associated with and then accesses that project's entry in the project database 70. The cost associated with the granting of that request is then deducted from the project's computing budget and the balance of the computing budget is resaved in the project database for that project.

It should be clear that, once a process has been granted access to one or more data processors, that process is allowed to use those allocated data processors until the process is complete (i.e. an output has been achieved). The system therefore does not allocate time slices to processes but rather allocates data processor resources to a process until the process has been completed or until some other event occurs that ends/suspends/pauses that process. Once completed, the process is deleted and the container associated with the completed process is similarly deleted. The data regarding the completed process and the scheduling for that process is then entered into a log by the logging module 40. Such data may include the cost associated with assigning the relevant data processors to the process, the execution time for the process, resources used by the process (including data storage resources used by the process), and even identification of the data processors assigned to the completed process. The data entered into the log can be used to analyze the performance of whatever scheduling/optimization algorithms were in operation at the time.

It should also be clear that each process is associated with a specific project and that each project has an entry in the project database 70. Each project is assigned a computing budget by a central authority within the system. This budget is noted in the database entry for the project and, as processes for the project are executed, the costs of executing these processes are subtracted from the project budget by the billing module 30. In addition to the project's budget, the database entry for each project includes statistics for the project as well as statistics for all of the processes launched and executed for the project.

Regarding the cost for scheduling one or more data processors for a specific process, this cost may be implementation dependent. As an example, a sliding scale cost structure may be employed such that, when the governor module 20 receives a request from a process, the relevant process agent provides the governor module with the required resources or assets for that process to execute. This data may thus determine the cost for scheduling the execution of the process with more resources being consumed having a higher cost. The projected resource costs for a process may include the number of data processors that need to be assigned to the process, the possible number of cycles (i.e. execution time) for the process, and possibly even the amount of data storage needed for the process. Thus, a process needing access to 2 data processors would have a lower cost associated with execution than a process needing access to 4 or 8 data processors. Similarly, a process needing access to 2 data processors for an estimated 5 execution cycles would have a lower execution cost than a process needing access to 2 data processors for an estimated 6 execution cycles.

Conversely, the governor module may implement a scheduling algorithm that takes into account an importance of a project when scheduling processes. Thus, each project can be assigned an “importance” or priority number with higher priority numbers processes taking precedence from lower priority number processes. Of course, such a scheme may result in lower priority processes having longer wait times to execute than regular priority processes.

A different scheduling algorithm may also be implemented where each project assigns an importance to a process by “bidding” on an earlier scheduling slot. Thus, an important process may, for example, be allowed to bid an extra x units of cost in addition to the regular cost of scheduling for execution. The end result would be that, for two processes requiring the exact same amount of resources, a more important process (or a process deemed to be more important within the project for a quicker execution) would be allowed to allocate a higher cost to itself. Thus, if two processes both required resources that would normally cost 10 units of cost, one of these processes would be allowed to “bid” an extra 5 units of cost to be scheduled earlier. This more “important” process would thus have an execution cost of 15 cost units as opposed to a similar process for which, while needing the exact same amount of resources, execution would only cost 10 units.

As a variant of the above, each scheduled process may be given a set/predetermined cost with a baseline for the amount of data processors required and estimated execution time (e.g. each process requiring one or a portion thereof of a data processor with an estimate execution time of 10 cycles would have a fixed cost of 10 units). As a process requires more data processors and/or more execution time, a sliding scale may be applied to calculate the cost for a process (e.g. every extra data processor required costs an extra 5 units and every extra estimated unit of execution time would cost an extra 10 units).

It should be clear that the system illustrated in FIG. 1 can be used to test, manage, and optimize different scheduling algorithms. As well, the system may be used such that one or more metrics are maximized. In one example, the system may be used to maximize the number of processes completed per unit time. Similarly, the system may be used to maximize the number of projects completed per unit time. Or, in another variant, the utilization metric for all the data processors may be maximized (i.e. maximizing the amount of time that the data processors are occupied and being utilized).

The system in FIG. 1 may also include the cloud controller 100 that can be used to offload processes and storage to cloud-based processors or storage units. Thus, since cloud-based processors may not be as fast as on-site data processors, the governor module may assign lower costs for scheduling processes for execution by a cloud-based processor. Similarly, if data storage is also assigned a cost in the system (i.e. storing data will cost a process and its project a portion of its budget) cloud-based storage may also be given as discount versus on-site storage. Thus, usage of the storage manager module 90 may have a higher associated cost for processes than using cloud storage.

For ease of implementation, each process may be assigned a process ID to assist in identifying the process to the various modules of the system. As well, a project ID may also be used to identify and differentiate different projects to the various modules of the system. For ease of implementation, the process ID may be related to the project ID of the project to which the process is associated with.

In one variant of the present invention, the governor module takes into account a requesting process's status when scheduling data processors. Thus, an interactive process (i.e. one that requires user interaction) would always be processed/scheduled immediately. This method seeks to avoid inordinate amounts of deadtime when the data processor is waiting for user input. Of course, depending on the algorithms implemented, interactive processes may have a higher cost associated with them since interactive processes are scheduled and executed immediately, thereby taking precedence from other processes.

As noted above, the system may be used to optimize different metrics and to minimize different loss functions. Depending on the desired outcome and the desired efficiencies, the system may be used to optimize productivity, efficiency, hardware utilization, actual real-world costs associated with operating the different data processors, as well as application run-time/execution time.

In addition to the above, various methods for allocating budgets to projects and to processes may be used with the system described in this document. As an example, the budgets may be allocated on a rolling basis with each project having a budget renewed/reviewed after a set period of time. Alternatively, each project may be allocated a set budget that is not changed until the budget has been exhausted. Clearly, the system may also be used to implement an economic system between the various projects and processes, with a “central bank” entity allocating/renewing/reviewing budgets to projects or otherwise operating system or component parameters to thereby exert a measure of control over the economic system.

It should be clear that the above described system can be used to implement processes and methods that mimic both micro- and macro-economic systems using the system's assets and GPU processing time and storage as the currency in the economic system. In one variant, control over the economic system can be exerted by controlling the overall access to the GPUs and to storage assets. As well, control over allocated budgets can also be used to more directly control the economy in the system in much the same way that macroeconomic central banks exert indirect control over the money supply using interest rates.

It should be clear that the system illustrated in FIG. 1 can be implemented as a number of software modules executing on one or more data processors.

Also for ease of implementation, when a data processor is assigned to a process, that process is also provided with access to a set amount of RAM for use by the data processor. Thus, when a process is scheduled for execution by two data processors, the process has access to double the amount of RAM that a process assigned to a single data processor would have access to. For ease of implementation, this scheme can be extrapolated so that, for example, a process A assigned to a single data processor would have access to n GB of RAM while process B assigned to four data processors would have access to 4n GB of RAM.

For clarity, whenever the above description refers to an entity “receiving” data, the receiving entity may receive such data in response to an express request from that entity for such data. Similarly, the entity receiving the data may receive such data without performing an express step that requests for such data. The receiving entity may thus be an active entity in that it requests data before receiving such data or the receiving entity may be a passive entity such that the entity passively receives data without having to actively request such data. Similarly, an entity that “sends” or “transmits” data to another entity may send such data in response to a specific request or command for such data. The data transmission may thus be a “data retrieval” with the sending entity being commanded to retrieve and/or search and retrieve specific data and, once the data has been retrieved, transmit the retrieved data to a receiving entity. It should also be clear that the receiving entity may be the entity that commands/requests such data or the command/request for such data may come from a different entity.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for scheduling multiple processes for access to multiple data processors, the system comprising:
a governor module for determining which modules are to be assigned to which data processors based on an optimization of at least one loss function;
a billing module for subtracting a cost of a process accessing at least one of said multiple data processors from a project's computing budget when a process is scheduled for execution on at least one of said multiple data processors, each process being associated with a specific project and each project being assigned a predetermined computing budget;
a log module for logging schedules and costs for each process scheduled for execution on one of said multiple data processors;
a project database for storing data relating to each project, said data including each project's remaining computing budget and parameters for each project;
a plurality of process agents, each process agent being specific to one of said multiple processes, each process agent being for providing parameters and data regarding a specific process to said governor module;
a request database for storing requests from said multiple processes for access to one or more data processors of said multiple data processors, said requests in said request database including an identification of a process making said request;
wherein
when said governor module receives a request from said request database, said governor module receives data and parameters for a process making said request from a request agent specific to said process making said request.

2. The system according to claim 1, wherein said multiple data processors comprises one or more GPUs.

3. The system according to claim 1, wherein said loss function is productivity related.

4. The system according to claim 1, wherein said loss function is expense related.

5. The system according to claim 1, further comprising a storage manager for managing storage requirements of said multiple processes.

6. The system according to claim 1, further comprising a cloud computing controller for managing access to cloud computing resources allocated by said governor module to said processes.

7. The system according to claim 1, wherein said governor module schedules processes requiring user interactions prior to other non-interactive processes.

8. The system according to claim 1, wherein each data processor is allocated a predetermined amount of dedicated random access memory such that access to a data processor by a process allows said process to access said predetermined amount of dedicated RAM.

9. The system according to claim 8, wherein providing a specific process with access n data processors provides said specific process access to an amount of RAM equal to said predetermined amount multiplied by n.

10. A system according to claim 1 wherein said governor module receives said request from said request database in response to said governor module requesting input from said request database.

11. A system according to claim 1 wherein said governor module receives data and parameters for said process making said request from said request agent in response to said governor module requesting said data and parameters from said request agent.
